(19) United States
(12) Patent Application Publication
(10) Pub. No.: US 2006/0076465 A1
(43) Pub. Date: Apr. 13, 2006

(54) Height-adjusting device

(75) Inventor: Byung-Hoon Park, Suwon-Si (KR)

Correspondence Address: Peter T. Kwon, Kangnam P. O. Box 2301, Seoul, 135-242, KR

(73) Assignee: Elite Furniture Co., Ltd.

(21) Appl. No.: 11/026,461

(22) Filed: Dec. 30, 2004

(30) Foreign Application Priority Data
Oct. 13, 2004 (KR) 2004-0081786

(51) Int. Cl. F16M 11/24

(52) U.S. Cl. 248/188.5

(57) ABSTRACT

A height-adjusting device is disclosed. The height-adjusting device includes a height-fixing device constructed such that the inner support is inserted into the outer support and moves vertically, and the bolts are fastened with the nuts through the inner and outer supports so that the height of the inner support is fixed to the desired position within the outer support and the adjusted height is maintained for extended periods of time, being applied to chairs, desks, tables, hangers, and the like, and capable of maintaining the adjusted height for extended periods of time. The height-adjusting device improves inconvenience in use due to frequent breakdown or malfunction of the conventional height-adjusting device, so that productivity and reliability of the height-adjusting device are enhanced so as to enable consumers assume the height-adjusting device good.

### BACKGROUND OF THE INVENTION

1. Field of the Invention

The present invention relates to a height-adjusting device, and more particularly to a height-adjusting device applied to chairs, desks, tables, hangers, and the like, capable of maintaining the adjusted height for extended periods of time, and having a simple structure to prevent problems occurring in conventional height-adjusting devices such as frequent breakdown or malfunction height-adjusting so that productivity and reliability of the height-adjusting device are enhanced and height-adjusting consumer satisfaction is enhanced.

2. Description of the Prior Art

As is well known, there are various height-adjusting devices for adjusting the height of chairs, desks, tables, hangers, or the like.

In other words, the conventional height-adjusting devices are divided into devices using pins and devices using the elastic force of springs, and these height-adjusting devices adjust the height of chairs, desks, tables, hangers, or the like.

However, conventional height-adjusting devices are inconvenient to use, due to frequent breakdown height- adjusting.

In other words, the conventional height-adjusting device using pins has drawbacks such that the pin is easily separated by shock. The conventional height-adjusting device using springs has drawbacks such that the spring is deteriorated as time passes. Moreover, even after adjusting the height, the stiffness of the spring and/or malfunction of connected portions can result in user inconvenience.

### SUMMARY OF THE INVENTION

Therefore, the present invention has been made in view of the above problems, and it is an object of the present invention to provide a height-adjusting device constructed such that the inner support is inserted into the outer support and moves vertically, and the bolts are fastened with the nuts through the inner and outer supports so that the height of the inner support is fixed to the desired position within the outer support and the adjusted height is maintained for extended periods of time.

It is another object of the present invention to provide a height-adjusting device being applied to chairs, desks, tables, hangers, and the like, and capable of maintaining the adjusted height for extended periods of time.

It is still another object of the present invention to provide a height-adjusting device having a simple structure to improve inconvenience in use due to frequent breakdown or malfunction of the conventional height-adjusting device.

It is still another object of the present invention to provide a height-adjusting device capable of enhancing productivity and reliability and enabling consumers assume the height-adjusting device good.

In accordance with an object of the present invention, the above and other objects can be accomplished by the provision of a height-adjusting device including a height-fixing device constructed such that the inner support is inserted into the outer support and moves vertically, and the bolts are fastened with the nuts through the inner and outer supports so that the height of the inner support is fixed to the desired position within the outer support and the adjusted height is maintained for extended periods of time.

### BRIEF DESCRIPTION OF THE DRAWINGS

These and/or other objects and advantages of the present invention will become apparent and more readily appreciated from the following description of the embodiments, taken in conjunction with the accompanying drawings, in which:

FIG. 1 is a view illustrating a height-fixing device employed in a height-adjusting device according to the preferred embodiment of the present invention.

FIG. 1a is a partial plan sectional of the height-fixing device.

FIG. 1b is a partial side sectional view of the height-fixing device.

FIG. 1c is a front sectional view of the height-fixing device.

FIG. 2 is a sectional view illustrating the height-fixing device of the height-adjusting device according to the present invention being coupled between an outer support and an inner support.

FIG. 3 is a perspective view illustrating the application of the height-fixing device of the height-adjusting device according to the preferred embodiment of the present invention to a chair.

FIG. 4 is a front view of the chair employing the height-adjusting device according to the preferred embodiment of the present invention in FIG. 3.

FIG. 5 is a side view of the chair employing the height-adjusting device according to the preferred embodiment of the present invention in FIG. 3.

FIG. 6a is a partial sectional view illustrating that a front foot, employed in the height-adjusting device according to the preferred embodiment of the present invention, is coupled to the leading end of the support.

FIG. 6b is a schematic view illustrating that a rear foot, employed in the height-adjusting device according to the preferred embodiment of the present invention, is coupled to the upper end of the support.

FIG. 6c is a partial sectional view illustrating that a cap, employed in the height-adjusting device according to the preferred embodiment of the present invention, is coupled to the top of the support.

### DESCRIPTION OF THE PREFERRED EMBODIMENTS

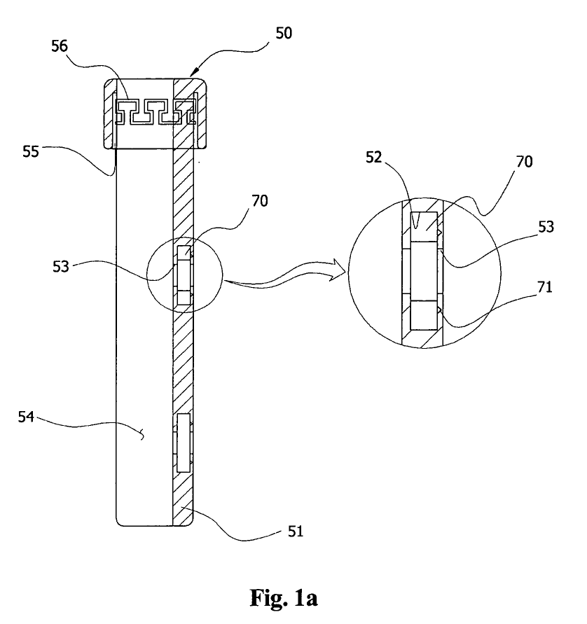

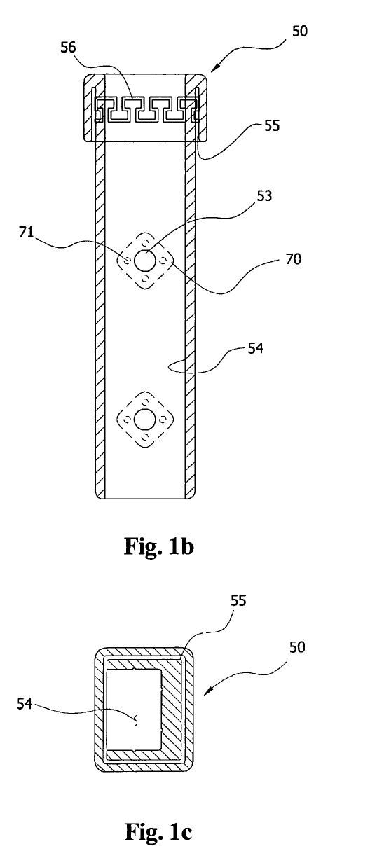

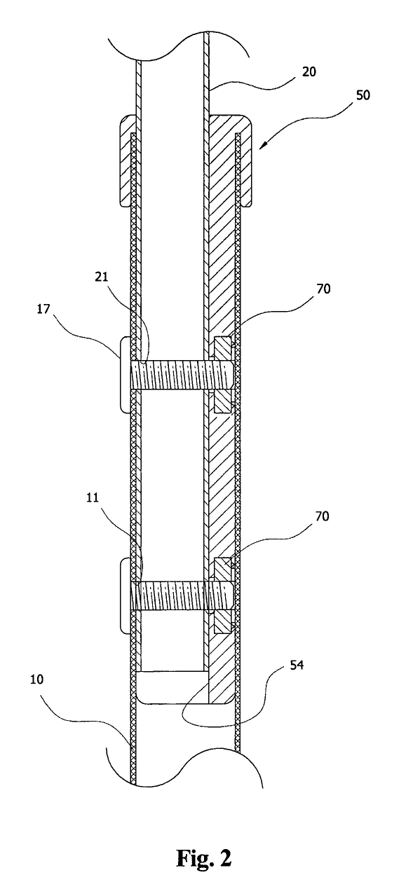

The height-adjusting device according to the preferred embodiment of the present invention is constructed as shown in FIGS. 1 through 6.

In the description of the present invention, if the description of well-known functions and structure may confuse the subject matter of the present invention, it will be omitted.

Since terminologies used in following description are defined by considering the function of the present invention and changed according to manufacture's purpose or usage, the definitions of the terminologies should be defined by considering whole contents of this application.

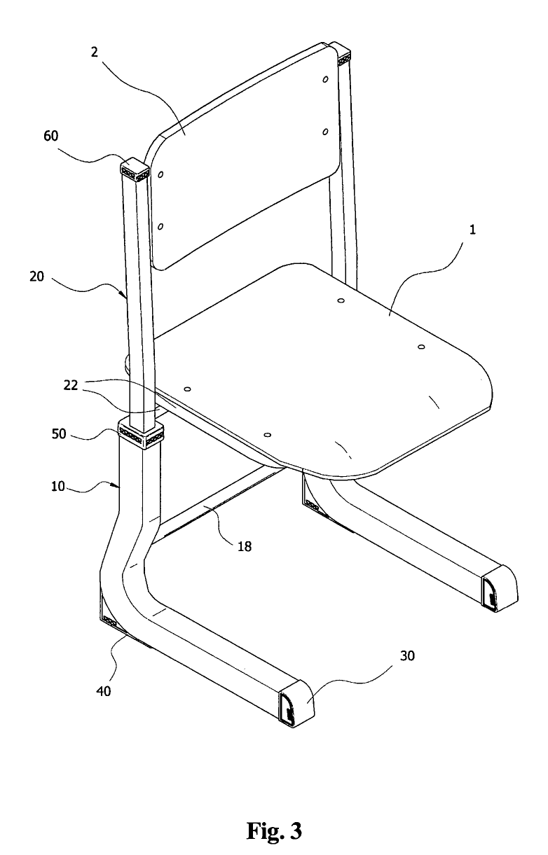

First, the height-adjusting device according to the preferred embodiment of the present invention is depicted as applied to a chair as shown in FIGS. 3, 4 and 5. However, this is only for the purpose of illustration, and the height-adjusting device according to the preferred embodiment of the present invention can be applied not only to the chair but also to desks, tables, hangers, and equipment necessary to adjust the heights thereof.

The height-adjusting device according to the preferred embodiment of the present invention includes a height-fixing device 50. The height-fixing device 50 is constructed such that an inner support 20 formed with a plurality of holes 21 is inserted into an outer support 10, formed with a plurality of holes 11 at regular intervals, through its upper end and moved vertically, and bolts 17 are inserted into the inner and outer supports 20 and 10 and coupled with nuts 70 to fix the position, namely, height of the inner support 20 to a desired position in the outer support 10, so that the height of the inner support 20 is maintained in the adjusted state for extended periods of time.

It is preferred that the inner and outer supports 20 and 10 are made of metal or other material, and the height-fixing device 50 is made of synthetic resin, but if necessary, can be made of other materials.

In more detail, the height-fixing device 50 has a support insertion hole 55 into which the outer support 10 is inserted through the lower side of the height-fixing device 50, a slide hole 54 into which the inner support 20 is inserted through the upper side and having an opened side, holes 53 and nut insertion holes 52 larger than the hole 53 formed at the inside of the height-fixing device 50, so that nuts 70 are inserted into the nut insertion holes 52.

The portions, in which the nut insertion holes 52 are formed, are provided with reinforcing portions thicker than other portions.

Moreover, the height-fixing device 50 is further formed with a patterned recess 56 at the upper outer circumference thereof.

In addition, the nuts 70 are formed with a plurality of metal protrusions 71 inserted into and fixed in the synthetic resin height-fixing device 50.

The height-adjusting device according to the preferred embodiment of the present invention further includes front feet 30 having protrusions 32 formed at the bottom and a patterned recess 31 formed at the outer surface and provided at the front sides of the “L”-shaped outer support 10.

Moreover, rear feet 40 having protrusions 42, formed at the bottom thereof, and a patterned recess 41, formed at the outer surface thereof, are provided at the rear bottom of the outer support 10.

The height-adjusting device of the present invention further includes caps 60 having a patterned recess provided at the upper sides of the inner support 20.

Reference numeral 1 indicates a seat of the chair, a reference number 2 indicates a back of the chair, a reference numeral 18 indicates a connecting bar installed between both outer supports 10, and reference numeral 22 indicates a support frame for supporting the seat 1.

Meanwhile, it should be understood that the present invention may take various forms and shapes when the above structure of the present invention is practically implemented.

Operation of the height-adjusting device according to the preferred embodiment of the present invention will be described in detail hereinafter.

First, the present invention overcomes the problems inherent in the conventional height-adjusting devices using pins or springs, adjusts the heights of chairs, desks, tables, hangers, and the like, and maintains the adjusted height for extended periods of time.

The present invention is constructed such that the upper end of the outer support 10 is coupled and fixed to the support insertion hole 55, the inner support 20 is inserted into the slide hole 54, the inner support 20 is inserted into the outer support 10 through the upper end of the outer support 10 and moves vertically, and the bolts 17 are fastened with the nuts 70 through the holes 11 and 21, so as to fix the height of the inner support 20 at a desired position and to maintain the adjusted height for extended periods of time.

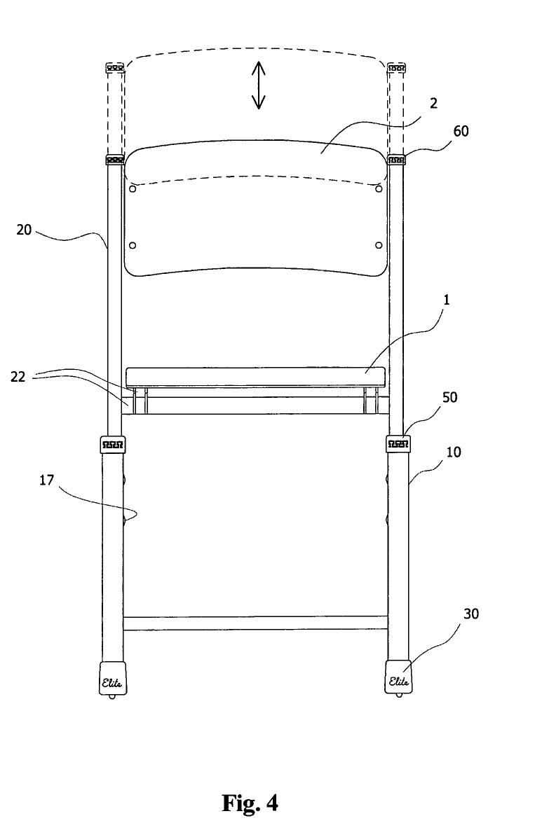

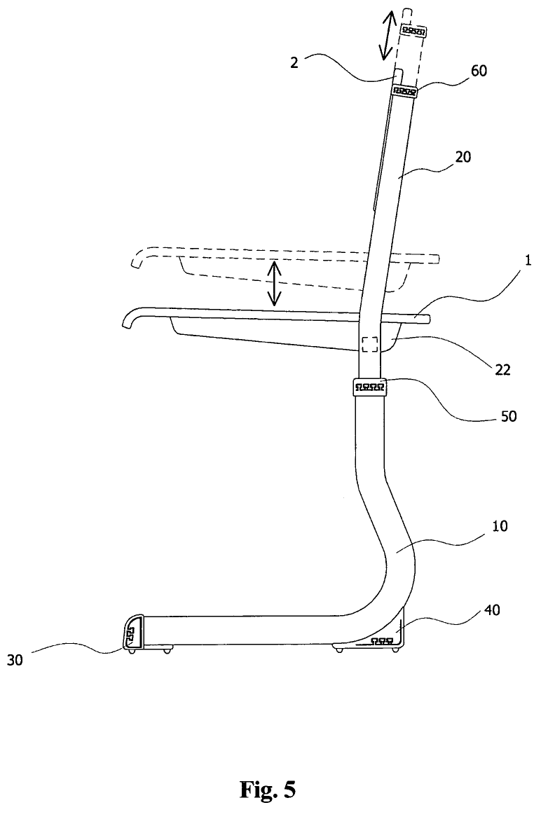

In other words, when raising the height of the seat 1 from the lowered position as indicated by a solid line in FIGS. 4 and 5, the bolts 17 are released and separated from the nuts 70. When the bolts 17 are separated from the nuts 70, the inner support 20 can freely move within the outer support 10 in the vertical direction.

In the above state, a user positions the height of the seat 1 to the desired position (indicated by a phantom line) and fastens the bolts 17 with the nuts 70, so that the height of the seat 1 is easily adjusted and fixed at the desired position.

Once the bolts 17 are fastened to the nuts 70, the height of the seat 1 is fixed in place and the seat 1 cannot be separated. In more detail, the nuts 70 provided to the height-fixing device 50 are inserted into the nut insertion holes 52, the nut insertion holes 52 are formed between the thick reinforcing portions 51 to bear a large load, and each nut 70 in the nut insertion hole 52 has three sides in close contact with the nut insertion hole 52 to prevent it from being separated by vibration or shock, so that the bolts 17 are not separated from the nuts 70 even in the case of long term usage. As a result the inner support 20 is firmly coupled and installed to the outer support 10.

In more detail, since each nut 70 insert-molded in the nut insertion hole 52 is fixed therein by inserting its protrusions 71 into the height-fixing device 50, the bolts 17 are firmly fixed without vibration when fastening or releasing the bolts 17 to or from the nuts 70, and since the nuts 70 move toward the bolts 17 when fastening the bolts 17, the slide hole 54 relatively near the nut insertion hole 52 comes in contact with the outer surface of the inner support 20 so as to fix the inner support 20 more firmly in the height-fixing device 50.

Since the height-adjusting device of the present invention can adjust the height using only the bolts 17, the height can be easily adjusted to any position.

Obviously, the reverse operation to that described above is conducted in order to lower the seat 1.

In addition, the height-adjusting device according to the preferred embodiment of the present invention further includes front feet 30, provided at the leading ends of the outer support 10, for protecting individuals from being by injured the sharp leading ends of the outer support 10, having the patterned recess 31 formed at the outer surface and providing an aesthetically pleasing appearance and the protrusions 32 formed at the bottom and absorbing shock so as to reduce noise generated when moving the chair.

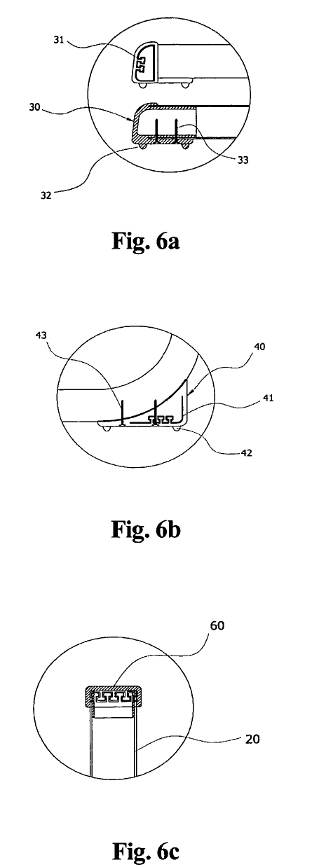

Moreover, the height-adjusting device according to the preferred embodiment of the present invention further includes the rear feet 40 provided at the rear bottom of the outer support 10, as shown in FIG. 6b, and having the protrusions formed at the bottom of the rear feet 40 and remarkably reducing noise generated when moving the chair and the patterned recess 41 providing an aesthetically pleasing appearance as described above.

In addition, the height-adjusting device according to the preferred embodiment of the present invention further includes an intermediate protector 50 provided at the top of the outer support 10 and the caps 60 provided at the top of the inner support 20 so as to protect individuals from injury by the sharp ends of the outer support 10 and the inner support 20 and providing an aesthetically pleasing appearance.

As described above, the height-adjusting device includes the height-fixing device constructed such that the inner support is inserted into the outer support and moves vertically, and the bolts are fastened with the nuts through the inner and outer supports so that the height of the inner support is fixed to the desired position within the outer support and the adjusted height is maintained for extended periods of time, being applied to chairs, desks, tables, hangers, and the like, capable of maintaining the adjusted height for extended periods of time, and having a simple structure to improve inconvenience in use due to frequent breakdown or malfunction of the conventional height-adjusting device, so that productivity and reliability of the height-adjusting device are enhanced so as to enable consumers assume the height-adjusting device good.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A height-adjusting device comprising:
a height-fixing means including:
an outer support,
an inner support inserted into the outer support through the upper side of the outer support and selectively moving vertically, and
a plurality of bolts fastened with nuts through the inner and outer supports so as to fix the height of the inner support within the outer support and to maintain the adjusted height of the inner support for extended periods of time.

2. The height-adjusting device as set forth in claim 1, wherein the height-fixing means has a support insertion hole into which the outer support is inserted through the lower side of the height-fixing means, a slide hole into which the inner support is inserted through the upper side of the height-fixing means and having an opened side, holes and nut insertion holes larger than the hole formed at the inside of the height-fixing device, so that nuts are inserted into the nut insertion holes.

3. The height-adjusting device as set forth in claim 2, wherein the portion where the nut insertion hole is formed is formed with reinforcing portions thicker than other portions.

4. The height-adjusting device as set forth in claim 2, wherein the height-fixing means is further formed with a patterned recess at the upper outer surface thereof.

5. The height-adjusting device as set forth in claim 2, wherein each nut further has a plurality of protrusions formed at the side thereof and inserted into and fixed in the height-fixing means.

6. The height-adjusting device as set forth in claim 2, further comprising front feet provided at the leading ends of the bent outer support, each front foot having protrusions formed at the bottom thereof and a patterned recess formed at the outer surface thereof.

7. The height-adjusting device as set forth in claim 6, further comprising rear feet provided at the rear bottom of the bent outer support, and each rear foot having protrusions formed at the bottom of the rear foot and a patterned recess formed at the outer surface of the rear foot.

8. The height-adjusting device as set forth in claim 2, further comprising caps provided at the upper ends of the inner support and formed with a patterned recess.
